(19) United States
(12) Patent Application Publication
(10) Pub. No.: US 2021/0042584 A1
(43) Pub. Date: Feb. 11, 2021

(54) INFORMATION PROCESSING APPARATUS, CONTROL METHOD, AND NON-TRANSITORY STORAGE MEDIUM

(71) Applicant: NEC CORPORATION, Tokyo (JP)

(72) Inventors: Ryota HIGA, Tokyo (JP); Itaru NISHIOKA, Tokyo (JP)

(73) Assignee: NEC CORPORATION, Tokyo (JP)

(21) Appl. No.: 16/965,823

(22) PCT Filed: Jan. 30, 2018
(86) PCT No.: PCT/JP2018/003043

§ 371 Date: Jul. 29, 2020

(51) Int. Cl. G06K 9/62; G06N 20/00

(52) U.S. Cl. CPC G06K 9/6263; G06N 20/00; G06K 9/6256

(57) ABSTRACT

An information processing device (2000) includes an acquisition unit (2020) and a learning unit (2040). The acquisition unit (2020) acquires one or more pieces of action data. The action data are data each piece of which associates a state vector representing a state of an environment with an action that is performed in a state represented by the state vector. The learning unit (2040) generates a policy function P and a reward function r through imitation learning using the acquired action data. The reward function r outputs, when given a state vector S as input, a reward r(S) that is acquired in a state represented by the state vector S. The policy function accepts, as input, an output r(S) of the reward function upon input of a state vector S and outputs an action a=P(r(S)) to be performed in a state represented by the state vector S.

### TECHNICAL FIELD

The present invention relates to machine learning.

### BACKGROUND ART

In reinforcement learning, with respect to an agent (a person or a computer) that performs actions in an environment the state of which may change, appropriate actions depending on the state of the environment are learned. As used herein, a function that outputs an action depending on the state of the environment is referred to as a policy function. Performing learning of the policy function causes the policy function to come to output an appropriate action depending on the state of the environment.

Examples of prior art documents dealing with the reinforcement learning includes Patent Document 1. Patent Document 1 discloses a technology to, when a difference due to disturbance occurs between an environment in which learning was performed and an environment after learning, select appropriate actions in consideration of the disturbance.

### RELATED DOCUMENT

### Patent Document

[Patent Document 1] Japanese Unexamined Patent Publication No. 2006-320997

### SUMMARY OF THE INVENTION

### Technical Problem

In the reinforcement learning, as a prerequisite, a reward function is given that outputs a reward that is defined for an action of an agent and a state to which the environment transitions caused by the action of the agent. The reward is a criterion by which an action of the agent is evaluated, and, based on the reward, an evaluation value is determined. For example, the evaluation value is the sum of rewards that are obtained while the agent performs a series of actions. The evaluation value is an index for determining an objective of actions of the agent. For example, learning of a policy function is performed in such way as to achieve an objective such as “maximizing the evaluation value”. Note that, since the evaluation value is determined based on the reward, it can be said that the learning of a policy function is performed based on a reward function.

In order to appropriately perform the learning of a policy function in accordance with the above-described method, it is required to appropriately design a reward function and an evaluation function (a function to output an evaluation value). That is, in what manner actions of the agent are evaluated, the objective of actions of the agent, and the like are required to be appropriately designed. However, it is often difficult to appropriately design a reward function and an evaluation function, and, in such a case, it is difficult to appropriately perform the learning of a policy function.

The present invention has been made in consideration of the above-described problems. One of the objects of the present invention is to provide a novel technology to learn a policy of actions of an agent.

### Solution to Problem

An information processing apparatus according to the present invention includes 1) an acquisition unit that acquires one or more pieces of action data that are data each piece of which associates a state vector representing a state of an environment with an action that is performed in a state represented by the state vector and 2) a learning unit that generates a policy function P and a reward function r through imitation learning using the acquired action data. The reward function r outputs, when given a state vector S as input, a reward r(S) that is acquired in a state represented by the state vector S. The policy function accepts, as input, an output r(S) of the reward function upon input of a state vector S and outputs an action a=P(r(S)) to be performed in a state represented by the state vector S.

A control method according to the present invention is a control method performed by a computer. The control method includes 1) an acquisition step of acquiring one or more pieces of action data that are data each piece of which associates a state vector representing a state of an environment with an action that is performed in a state represented by the state vector and 2) a learning step of generating a policy function P and a reward function r through imitation learning using the acquired action data. The reward function r outputs, when given a state vector S as input, a reward r(S) that is acquired in a state represented by the state vector S. The policy function accepts, as input, an output r(S) of the reward function upon input of a state vector S and outputs an action a=P(r(S)) to be performed in a state represented by the state vector S.

A program according to the present invention causes a computer to perform each step that the control method according to the present invention includes.

### Advantageous Effects of Invention

The present invention enables a novel technology to learn a policy of actions of an agent to be provided.

### BRIEF DESCRIPTION OF THE DRAWINGS

The above-described object and other objects, features, and advantages will be more apparent by the preferred example embodiments described below and the following drawings accompanying therewith.

FIG. 1 is a diagram illustrating an example of a situation that an information processing apparatus of a first example embodiment assumes;

FIG. 2 is a diagram illustrating an example of a functional configuration of the information processing apparatus of the first example embodiment;

FIG. 3 is a diagram illustrating an example of a computer for achieving the information processing apparatus;

FIG. 4 is a flowchart illustrating an example of a processing flow that is performed by the information processing apparatus of the first example embodiment;

FIG. 5 is a flowchart illustrating an example of a processing flow of generating a policy function and a reward function;

FIG. 6 is a diagram illustrating an example of a functional configuration of an information processing apparatus of a second example embodiment;

FIG. 7 is a flowchart illustrating an example of a processing flow that is performed by the information processing apparatus of the second example embodiment;

FIG. 8 is a diagram illustrating an example of a functional configuration of an information processing apparatus of a third example embodiment;

FIG. 9 is a flowchart illustrating an example of a processing flow that is performed by the information processing apparatus of the third example embodiment;

FIG. 10 is a flowchart illustrating an example of a processing flow that is performed by an information processing apparatus of a fourth example embodiment; and

FIG. 11 is a diagram illustrating an example of a situation that is assumed in general reinforcement learning.

### DESCRIPTION OF EXEMPLARY EMBODIMENTS

Hereinafter, example embodiments of the present invention will be described using the drawings. In all the drawings, the same signs are assigned to the same constituent elements, and a description thereof will not be repeated. Unless specifically described, in block diagrams, each block represents a component as a functional unit instead of a hardware unit.

### First Example Embodiment

### <Outline>

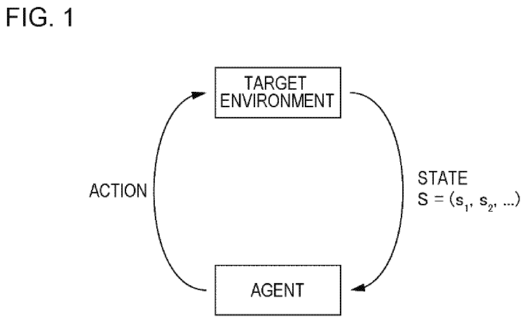

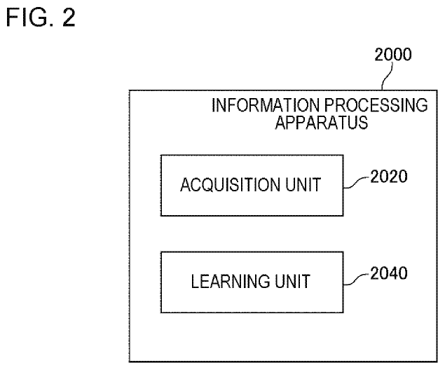

FIG. 1 is a diagram illustrating an example of a situation that an information processing apparatus 2000 (an information processing apparatus 2000 in FIG. 2) of a first example embodiment assumes. The information processing apparatus 2000 assumes an environment (hereinafter, referred to as a target environment) that may have a plurality of states and an actor (hereinafter, referred to as an agent) that may perform a plurality of actions in the environment. A state of the target environment is represented by a state vector S=(s1, s2, . . .).

Examples of the agent include a self-driving vehicle. The target environment in this case is expressed as a set of a state of the self-driving vehicle, a state of surroundings of the self-driving vehicle (a map of the surroundings, positions and velocities of other vehicles, a state of a road, and the like), and the like.

Actions to be performed by the agent differ depending on the state of the target environment. In the above-described case of a self-driving vehicle, although, when there is no obstacles in front, the vehicle can keep moving, when there is an obstacle in front, the vehicle is required to move in such a way as to avoid the obstacle. The vehicle is also required to change traveling velocity of the vehicle according to the state of a road surface ahead, inter-vehicle distance to a vehicle in front, and the like.

A function that outputs an action that the agent has to perform depending on the state of the target environment is referred to as a policy function. The information processing apparatus 2000 generates a policy function through imitation learning. When the policy function is formed into an ideal policy function through the learning, the policy function becomes a function that outputs an optimal action that the agent has to perform depending on the state of the target environment.

The imitation learning is performed by use of data (hereinafter, referred to as action data) each piece of which associates a state vector s with an action a. A policy function that is obtained through the imitation learning becomes a function that imitates provided action data. Note that, as an algorithm of the imitation learning, any existing algorithm can be used.

Further, the information processing apparatus 2000 of the present example embodiment also performs learning of a reward function through the imitation learning of a policy function. To do so, a policy function P is defined as a function that accepts as input a reward r(s) that is obtained by inputting a state vector s to a reward function r. Specifically, a policy function is defined as the formula (1) below. In the formula, a denotes an action that is obtained from the policy function.

### [Math. 1]

a=P(r(s)) (1)

That is, in the information processing apparatus 2000 of the present example embodiment, the policy function is formulated as a functional of a reward function. By performing the imitation learning after having defined a policy function formulated in this manner, the information processing apparatus 2000, while performing learning of the policy function, performs learning of a reward function and thereby generates the policy function and the reward function.

### <Advantageous Effects>

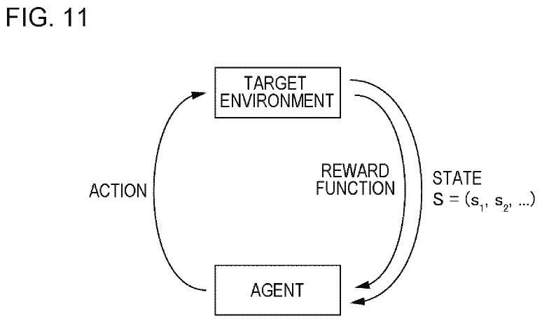

Learning ways for specifying an action that an agent has to perform in an environment that may have a plurality of states as described above include reinforcement learning. In the reinforcement learning, as a prerequisite, a reward function r is given that outputs a reward provided to an action of an agent (a state of a target environment appearing as a result of the action) (see FIG. 11). In addition, an evaluation value is defined based on the reward r(s). A policy function is learned, for example, based on an objective such as “maximizing the evaluation value”.

It is often difficult to appropriately design the reward function and the evaluation function. For example, a reward function and an evaluation function for achieving human-like actions are difficult to formulate. For example, it is assumed that a policy function to determine an action of a self-driving vehicle is generated. As one of appropriate actions of a self-driving vehicle, an action such as “travel providing a passenger with comfort” is conceivable. However, it is difficult to formulate the travel providing a passenger with comfort. Alternatively, for example, it is assumed that a policy function to determine an action of a computer that serves as an adversary against a person in a video game is generated. As one of appropriate actions of a computer in a video game, an action such as an “action making a person feel pleasure” is conceivable. However, it is difficult to formulate the action making a person feel pleasure.

In this respect, the information processing apparatus 2000 of the present example embodiment performs learning of a policy function through the imitation learning. Therefore, even in a situation in which it is difficult to formulate a reward function and an evaluation function, it is possible to generate a policy function that achieves appropriate actions. For example, by making a person who has a high driving skill drive a vehicle in such a way as to provide a passenger with comfort and performing the imitation learning by use of driving data obtained as a result of the drive, it is possible to generate a policy function that achieves the “travel providing a passenger with comfort”. Similarly, by making a person actually play a video game and performing the imitation learning by use of operation data obtained as a result of the play, it is possible to generate a policy function that achieves the “action making a person feel pleasure”.

Further, the information processing apparatus 2000 performs learning of a reward function through the learning of the policy function by means of the imitation learning. Therefore, the reward function obtained through the learning is a reward function based on actions to be imitated (for example, actions performed by a skilled person or the like). Thus, in what manner respective elements defining the state of the environment are treated in the reward function that has been learned represents in what manner a skilled person or the like treats the state of the environment. That is, by using the reward function that has been learned, it is possible to recognize information that can be said to represent a knack for actions performed by a skilled person or the like, that is, information on what element a skilled person or the like considers important in performing his/her actions. As described above, the information processing apparatus 2000 of the present example embodiment enables not only a policy function for representing actions that the agent has to perform to be learned by means of imitation but also importance or the like of respective elements in the state of the environment to be recognized through the learning of the policy function.

Hereinafter, the information processing apparatus 2000 of the present example embodiment will be described in more detail.

### <Example of Functional Configuration of Information Processing Apparatus 2000>

FIG. 2 is a diagram illustrating an example of a functional configuration of the information processing apparatus 2000 of the first example embodiment. The information processing apparatus 2000 includes an acquisition unit 2020 and a learning unit 2040. The acquisition unit 2020 acquires one or more pieces of action data. The action data are data each piece of which associates a state vector representing a state of a target environment with an action that is performed in the state represented by the state vector.

The learning unit 2040 generates a policy function P and a reward function r by use of imitation learning. The reward function r outputs, when given a state vector S as input, a reward r(S) that is obtained in a state represented by the state vector S. The policy function P outputs, when given as input an output r(S) of the reward function upon input of the state vector S, an action a to be performed in the state represented by the state vector S.

### <Hardware Configuration of Information Processing Apparatus 2000>

Each of the functional constituent units of the information processing apparatus 2000 may be achieved by hardware (for example, hardwired electronic circuits) that achieves each of the functional constituent units or achieved by a combination of hardware and software (for example, a combination of an electronic circuit and a program controlling the electronic circuit). Hereinafter, a case where each of the functional constituent units of the information processing apparatus 2000 is achieved by a combination of hardware and software will be further described.

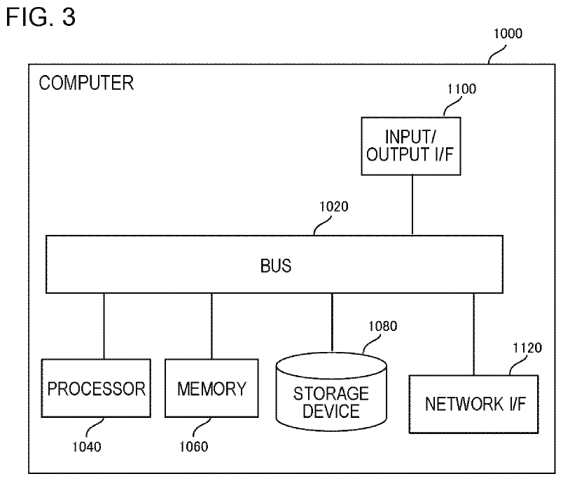

FIG. 3 is a diagram illustrating an example of a computer 1000 for achieving the information processing apparatus 2000. The computer 1000 is any computer. The computer 1000 is, for example, a personal computer (PC), a server machine, a tablet terminal, a smartphone, or the like. The computer 1000 may be a dedicated computer designed to achieve the information processing apparatus 2000 or a general-purpose computer.

The computer 1000 includes a bus 1020, a processor 1040, a memory 1060, a storage device 1080, an input/output interface 1100, and a network interface 1120. The bus 1020 is a data transmission line through which the processor 1040, the memory 1060, the storage device 1080, the input/output interface 1100, and the network interface 1120 transmit and receive data to and from one another. However, a method for interconnecting the processor 1040 and the like is not limited to the bus connection. The processor 1040 is a processor, such as a central processing unit (CPU), a graphics processing unit (GPU), and a field-programmable gate array (FPGA). The memory 1060 is a main storage apparatus achieved by use of a random access memory (RAM) or the like. The storage device 1080 is an auxiliary storage apparatus achieved by use of a hard disk drive, a solid state drive (SSD), a memory card, a read only memory (ROM), or the like. Note, however, that the storage device 1080 may be constituted by hardware similar to the hardware, such as a RAM, that constitutes the main storage apparatus.

The input/output interface 1100 is an interface for connecting the computer 1000 and input/output devices to each other. The network interface 1120 is an interface for connecting the computer 1000 to a network. The network is, for example, a local area network (LAN) or a wide area network (WAN). A method by which the network interface 1120 connects to a network may be wireless connection or wired connection.

The storage device 1080 stores program modules that achieve the functional constituent units of the information processing apparatus 2000. The processor 1040 reads and executes the respective program modules in the memory 1060 and thereby achieves the functions corresponding to the respective program modules.

### <Processing Flow>

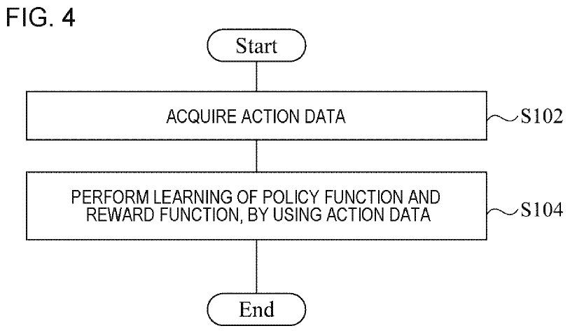

FIG. 4 is a flowchart illustrating an example of a processing flow that is performed by the information processing apparatus 2000 of the first example embodiment. The acquisition unit 2020 acquires action data (S102). The learning unit 2040 generates a policy function and a reward function through imitation learning using the action data (S104).

### <On Agent and Target Environment>

As an agent and a target environment, various objects can be treated. For example, as described afore, a self-driving vehicle can be treated as an agent. In this case, as described afore, the target environment is determined according to a set of a state of the self-driving vehicle, a state of surroundings of the self-driving vehicle, and the like. Alternatively, for example, a power generation apparatus can be treated as an agent. In this case, the target environment is determined according to a set of a current power generation amount by the power generation apparatus, an internal state of the power generation apparatus, a requested power generation amount, and the like. The power generation apparatus is required to perform change of the power generation amount and the like according to the states. Alternatively, for example, a player of a game can be treated as an agent. In this case, the target environment is determined according to the state of the game (in the case of, for example, shogi, the state of the board, captured pieces of the respective players, and the like). Each player of the game is required to perform appropriate actions depending on the state of the game in order to win over the adversary.

The agent may be a computer or a person. When the agent is a computer, configuring the computer in such a way that the computer performs actions obtained from a policy function that has been learned enables the computer to perform actions appropriately. Examples of the computer include control apparatuses that control a self-driving vehicle and a power generation apparatus.

On the other hand, when the agent is a person, making the person perform actions obtained from a policy function that has been learned enables the person to perform appropriate actions. For example, a driver of a vehicle driving the vehicle with reference to actions obtained from a policy function enables safe driving to be achieved. In addition, an operator of a power generation apparatus operating the power generation apparatus with reference to actions obtained from a policy function enables power generation with less waste to be achieved.

### <On Action Data>

Learning of a policy function and a reward function is performed by use of action data. As the action data, various types of data can be used. For example, the action data represent a history of actions that were performed in a target environment in the past (a history of what actions were performed in what states). It is suitable that the actions be actions that were performed by a skilled person who is familiar with the treatment of the target environment. However, the actions do not necessarily have to be limited to actions performed by a skilled person.

Alternatively, for example, the action data may represent a history of actions that were performed in an environment other than the target environment in the past. It is suitable that the environment be an environment that resembles the target environment. For example, when the target environment is a facility, such as a power generation apparatus, and actions are control of the facility, it can be conceived to, in order to perform learning of a policy function and a reward function with respect to a facility to be newly installed, use a history of actions performed on a facility that resembles the new facility and has already been put in operation.

The action data may be data other than a history of actions that were actually performed. For example, the action data may be manually generated. Alternatively, for example, the action data may be data generated in a random manner. That is, the action data are generated by associating with each state in a target environment an action selected at random out of the actions that can be performed. Alternatively, for example, the action data may be generated using a policy function that is used in another environment. That is, the action data are generated by associating with each state in the target environment an action obtained by inputting the state to the policy function used in the another environment. In this case, it is suitable that the “another environment” be an environment that resembles the target environment.

The generation of action data may be performed by the information processing apparatus 2000 or an apparatus other than the information processing apparatus 2000.

### <Acquisition of Action Data: S102>

The acquisition unit 2020 acquires one or more pieces of action data. As a method for acquiring the action data, any method may be employed. For example, the acquisition unit 2020 acquires the action data from a storage apparatus disposed inside or outside the information processing apparatus 2000. Alternatively, for example, the acquisition unit 2020 acquires the action data by receiving the action data transmitted by an external apparatus (for example, an apparatus that generated the action data).

### <On Policy Function>

To the policy function, at least a reward r(S) that is obtained by inputting a state vector S to a reward function r is given as input. For example, in the policy function, a range of values that the reward may take is divided into a plurality of subranges and, with each subrange, an action is associated. In this case, the policy function determines, when given a reward as input, a subrange in which the reward is included and outputs an action associated with the subrange. In the learning of the policy function, a way of dividing the range of values that the reward may take and actions to be associated with the respective subrange are determined.

### <On Reward Function>

The reward function outputs a reward corresponding to an input state vector. For example, the reward function is defined as a linear function. The reward function defined as a linear function is defined as a function of, as expressed by, for example, the formula (2) below, adding a bias b to a weighted sum of elements si constituting a state vector S.

$$\begin{matrix}[ Math . 2 ] & \\ r ( S ) = {\sum }_{i} {w}_{i} {s}_{i} + b & ( 2 )\end{matrix}$$

In the above formula, wi is a weight given to the i-th element si of the state vector S. The bias b is a real constant.

When the reward function is defined as described above, determination of the respective weights wi and the bias b is performed in the learning of the reward function. Note, however, that the reward function does not necessarily have to be defined as a linear expression and may be defined as a nonlinear function.

### <Generation of Policy Function and Reward Function: S104>

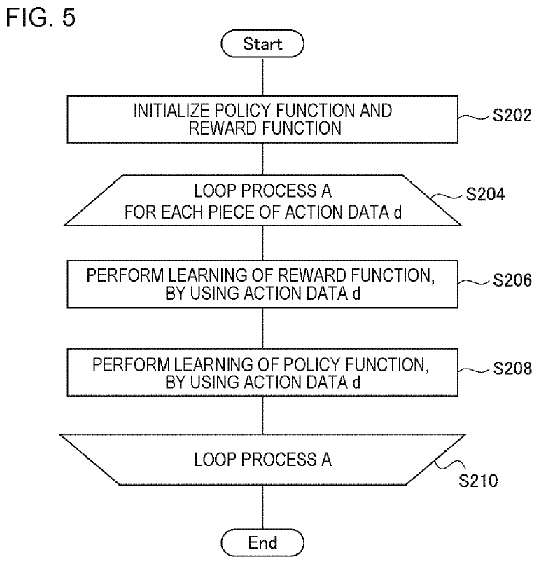

The learning unit 2040 generates a policy function and a reward function by use of imitation learning (S104). FIG. 5 is a flowchart illustrating an example of a processing flow of generating a policy function and a reward function.

The learning unit 2040 initializes a policy function and a reward function (S202). For example, the initialization is performed by initializing parameters of the policy function and the reward function with random values. Alternatively, for example, the policy function and the reward function may be initialized into the same functions as a policy function and a reward function that are used in an environment other than the target environment (the environment is preferably an environment resembling the target environment). The parameters of the policy function are, for example, the afore-described division of the range of values that the reward may take and actions associated with the respective subrange. The parameters of the reward function are, for example, the afore-described weights wᵢ and bias b.

The steps S204 to S210 are loop process A that is performed with each of the one or more pieces of action data as a target. In S204, the learning unit 2040 determines whether the loop process A has been performed with all the pieces of action data as targets. When the loop process A has already been performed with respect to all the pieces of action data, the processing in FIG. 5 terminates. On the other hand, when there exists a piece of action data that has not been targeted by the loop process A, the learning unit 2040 selects one of them, the processing in FIG. 5 proceeds to S206. The piece of action data that is selected in the step is referred to as action data d.

The learning unit 2040 performs learning of the reward function by use of the action data d (S206). Specifically, the learning unit 2040 uses a state vector S_{d} that the action data d indicates and obtain an action P(r(S_{d})) from the policy function. The action is an action obtained by inputting, to the policy function P, a reward r(S_{d}) that is obtained by inputting the state vector S_{d} to the reward function r.

The learning unit 2040 performs the learning of the reward function r, based on an action a_{d} indicated by the action data d and the action P(r(S_{d})) obtained from the policy function. The learning is supervised learning using the action data d as positive example data. Therefore, for the learning, any algorithm that achieves supervised learning can be used.

The learning unit 2040 performs learning of the policy function by use of the action data d (S208). Specifically, the learning unit 2040 performs the learning of the policy function, based on the action P(r(S_{d})) obtained by use of the reward function and the action as indicated by the action data d. The learning is also supervised learning using the action data d as positive example data. Therefore, as with the learning of the reward function, for the learning of the policy function, any algorithm that achieves supervised learning can also be used. Note that, in the learning of the policy function, the reward function that has been updated in the previous step S206 may be used or the reward function before update may be used.

Since S210 is the end of the loop process A, the processing in FIG. 5 returns to S204.

As described above, performing the loop process A with respect to each of the one or more pieces of action data causes the learning of the reward function and the policy function to be successively performed. The reward function and the policy function after the loop process A has been completed are set as a reward function and a policy function generated by the learning unit 2040, respectively.

Note that the flow illustrated in FIG. 5 is only an exemplification and the processing flow of generating a policy function and a reward function is not limited to the flow illustrated in FIG. 5. For example, the sequence of the learning of a reward function and the learning of a policy function may be reversed. That is, it is configured such that the learning of a policy function is performed in S206 and the learning of a reward function is performed in S208. In this case, the policy function used in the learning of a reward function in S208 may be a policy function after having been updated in the previous step S206 or a policy function before being updated in S206.

Note that, in the case where a reward function before update is used for the learning of a policy function and the case where a policy function before update is used for the learning of a reward function, the update of the policy function and the update of the reward function are performed independently with respect to a piece of action data. Therefore, in this case, S206 and S208 can be performed in parallel in the loop process A.

### Second Example Embodiment

### <Outline>

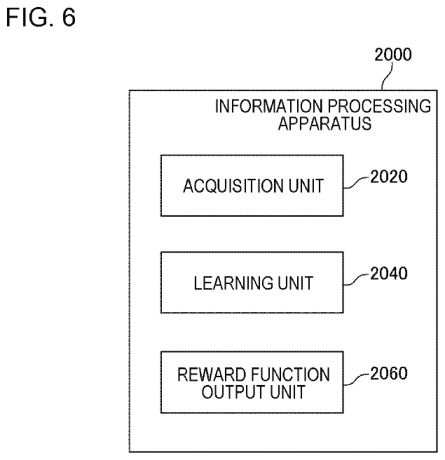

FIG. 6 is a diagram illustrating an example of a functional configuration of an information processing apparatus 2000 of a second example embodiment. With the exception of a point that will be described below, the information processing apparatus 2000 of the second example embodiment has the same functions as those of the information processing apparatus 2000 of the first example embodiment.

The information processing apparatus 2000 of the second example embodiment includes a learning result output unit 2060. The learning result output unit 2060 outputs information representing a reward function. For example, the learning result output unit 2060 outputs the reward function itself. Alternatively, for example, the learning result output unit 2060 may output information (for example, a correspondence table) representing associations of the respective elements of a state vector with weights.

Note that the information representing the reward function can be output in any form, such as a character string, an image, and a sound. For example, information representing the reward function by means of a character string or an image is displayed on a display apparatus on which a person (a user of the information processing apparatus 2000) who wants to obtain information on the reward function can browse such information. Information representing the reward function by means of a sound is output from a speaker that is placed in the vicinity of a person who wants to obtain information on the reward function.

### <Example of Hardware Configuration>

A hardware configuration of a computer that achieves the information processing apparatus 2000 of the second example embodiment is, as with the first example embodiment, for example, illustrated by FIG. 3. Note, however, that, in a storage device 1080 in a computer 1000 that achieves the information processing apparatus 2000 of the present example embodiment, program modules that achieve the functions of the information processing apparatus 2000 of the present example embodiment are further stored.

### <Processing Flow>

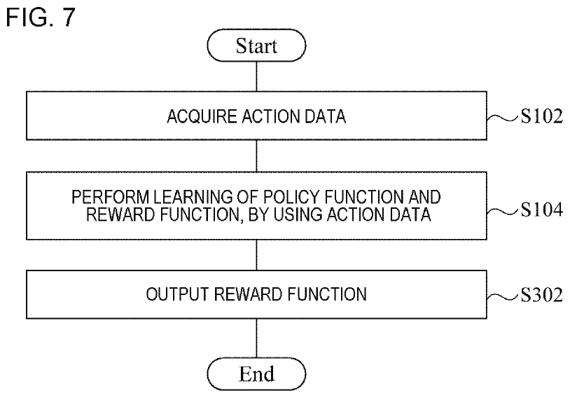

FIG. 7 is a flowchart illustrating an example of a processing flow that is performed by the information processing apparatus 2000 of the second example embodiment. Note that S102 and S104 are the same as those in FIG. 4. The learning result output unit 2060 outputs information representing the reward function after the processing in S104 has been performed (S302).

### <Advantageous Effects>

The information processing apparatus 2000 of the present example embodiment enables a reward function that is learned by a learning unit 2040 to be recognized. The reward function includes weights given to the respective element of a state vector S. Therefore, obtaining information on the reward function enables which element among elements determining the state of an environment is important in determining an action of an agent to be recognized.

Note that the learning result output unit 2060 may further output information representing a policy function in addition to the information representing the reward function. For example, it is assumed that, as described afore, the policy function is a function that associates each action that the agent has to perform with a range (subrange) of values that a reward may take. In this case, the information representing the policy function is, for example, information (for example, a correspondence table) that associates actions with subranges.

The method of outputting the reward function and the policy function is not limited to a method of, as described afore, displaying the reward function and the policy function on a display apparatus or outputting the reward function and the policy function from a speaker. For example, the learning result output unit 2060 may store the reward function and the policy function in a storage apparatus disposed inside or outside the information processing apparatus 2000. To the information processing apparatus 2000, a function of reading the reward function and the policy function stored in the storage apparatus on an as-needed basis is also provided.

### Third Example Embodiment

### <Outline>

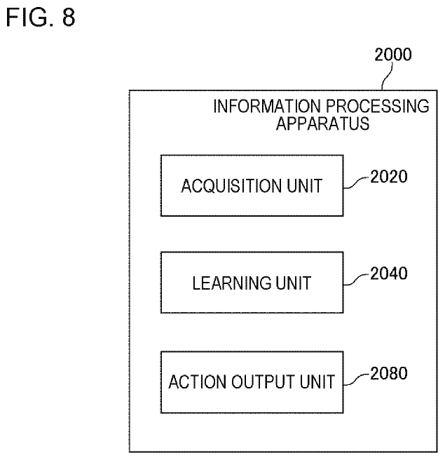

FIG. 8 is a diagram illustrating an example of a functional configuration of an information processing apparatus 2000 of a third example embodiment. With the exception of a point that will be described below, the information processing apparatus 2000 of the third example embodiment has the same functions as those of the information processing apparatus 2000 of the first example embodiment or the information processing apparatus 2000 of the second example embodiment.

The information processing apparatus 2000 of the second example embodiment includes an action output unit 2080. The action output unit 2080 acquires a state vector representing the current state of a target environment and determines, by use of the state vector, a reward function, and a policy function, an action that an agent has to perform. More specifically, the action output unit 2080 inputs, to a policy function P, a reward r(S) that is obtained by inputting an acquired state vector S to a reward function r. The action output unit 2080 outputs information representing an action P(r(S)) obtained from the policy function as a result of the input as information representing an action that the agent has to perform.

### <Example of Hardware Configuration>

A hardware configuration of a computer that achieves the information processing apparatus 2000 of the third example embodiment is, as with the first example embodiment, for example, illustrated by FIG. 3. Note, however, that, in a storage device 1080 in a computer 1000 that achieves the information processing apparatus 2000 of the present example embodiment, program modules that achieve the functions of the information processing apparatus 2000 of the present example embodiment are further stored.

### <Processing Flow>

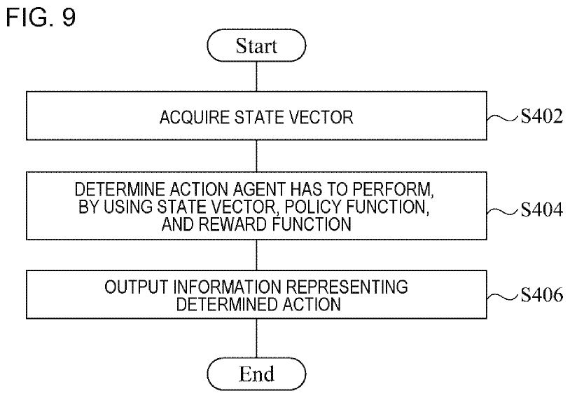

FIG. 9 is a flowchart illustrating an example of a processing flow that is performed by the information processing apparatus 2000 of the third example embodiment. The action output unit 2080 acquires a state vector representing the current state of an environment (S402). The action output unit 2080 determines, by use of the acquired state vector, a reward function, and a policy function, an action P(r(S)) that an agent has to perform (404). The action output unit 2080 outputs information representing the determined action P(r(S)) (S406).

### <Acquisition of State Vector: S402>

The action output unit 2080 acquires a state vector representing the current state of the environment. As a method of, when determining an action that the agent has to perform depending on the state of the environment, obtaining information representing the current state (for example, in the control of a self-driving vehicle, information representing a state of the vehicle, a state of a road surface, presence or absence of an obstacle, and the like), any existing technology can be used.

### <Determination of Action: S404>

The action output unit 2080 determines an action that the agent has to perform (S404). The action can be determined as P(r(S)) by use of the state vector S, the reward function r, and the policy function P.

### <Output of Determined Action: S406>

The action output unit 2080 outputs the action that was determined in S4004 (S406). As described afore, the agent may be a computer or a person.

When the agent is a computer, the action output unit 2080 outputs information representing the action that was determined in S404 in a mode that the computer can recognize. For example, the action output unit 2080 outputs, to the agent, a control signal to make the agent perform the determined action.

For example, it is assumed that the agent is a self-driving vehicle. In this case, the action output unit 2080, for example, outputs various types of control signals (for example, signals indicating a steering angle, a throttle opening, and the like) to a control apparatus, such as an electronic control unit (ECU), that is disposed in the self-driving vehicle and thereby makes the self-driving vehicle perform actions determined by the policy function.

When the agent is a person, the action output unit 2080 outputs the action that was determined in S 404 in a mode that the person can recognize. For example, the action output unit 2080 outputs the name and the like of a determined action in a mode such as a character string, an image, and a voice. A character string or an image that expresses the name and the like of an action is displayed on, for example, a display apparatus on which the agent can browse such information. A voice that expresses the name and the like of an action is output from, for example, a speaker that is present in the vicinity of the agent.

For example, it is assumed that a driver, referring to actions determined by the policy function, drives a vehicle. In this case, the names and the like of actions determined by the action output unit 2080 are output from a display apparatus or a speaker disposed in the vehicle. The driver performing driving operation in accordance with the output enables the vehicle to travel in appropriate movement based on the policy function.

### Fourth Example Embodiment

With the exception of a point that will be described below, an information processing apparatus 2000 of a fourth example embodiment has the same functions as those of any of the information processing apparatuses 2000 of the first to third example embodiments.

In the information processing apparatus 2000 of the present example embodiment, by further performing learning with respect to a policy function and a reward function that were generated through the afore-described learning, based on actions that have subsequently actually been performed in a target environment, the policy function and the reward function are updated. Specifically, an acquisition unit 2020 further acquires action data. A learning unit 2040 performs learning of the policy function and the reward function by use of the action data and thereby updates the policy function and the reward function.

The action data that are acquired by the acquisition unit 2020 in the above processing are a history of actions that were actually performed in the target environment. It is preferable that the action data be a history of actions that a skilled person performed. However, it is not necessarily required to acquire a history of actions performed by a skilled person.

It is suitable that the information processing apparatus 2000 of the fourth example embodiment repeatedly perform operation such as “acquiring action data and updating, by use of the action data, the policy function and the reward function”. For example, the information processing apparatus 2000 performs the update periodically. That is, the information processing apparatus 2000 periodically acquires action data and performs, by use of the acquired action data, learning of the policy function and the reward function. However, the update of the policy function and the like by the information processing apparatus 2000 does not necessarily have to be performed periodically. For example, the information processing apparatus 2000 may perform, on the occasion of receiving action data transmitted from an external apparatus, the update using the received action data.

The learning unit 2040 performs, in accordance with the method described in the first example embodiment, learning of the policy function and the reward function by use of the acquired action data. This configuration causes the policy function and the reward function to be updated. A combination of the updated policy function and reward function is subsequently used in determination of actions that an agent has to perform (processing performed by an action output unit 2080) and output of a learning result (processing performed by a learning result output unit 2060).

However, the learning unit 2040 does not necessarily have to update the combination of the previous policy function and reward function with a combination of a policy function and a reward function that are obtained through learning using newly acquired action data.

Specifically, the learning unit 2040 compares a combination of a policy function and a reward function that were obtained in the past learning with a combination of a policy function and a reward function that are newly obtained and determines the more appropriate one as a policy function and a reward function after update. A policy function and a reward function that are obtained in the n-th round of learning are denoted by Pₙ and rₙ, respectively. When the learning unit 2040 performs the learning n times, a history of combinations (P₁, r₁), (P₂, r₂), . . . , and (Pₙ, rₙ) of a policy function and a reward function is obtained.

For example, the learning unit 2040 determines, out of the history, a combination of a policy function and a reward function that is to be employed as a learning result. In a conceptual sense, the learning unit 2040 employs a combination of a policy function and a reward function that best imitates action data out of the combinations of a policy function and a reward function that have hitherto been generated.

For example, it is assumed that the learning unit 2040 acquires a set Dₙ of action data in7 the n-th round of learning ((n-1)th update) and obtains a policy function Pₙ and a reward function rₙ by performing the learning using action data included in Dₙ. In this case, a degree to which each combination (Pᵢ, rᵢ) of a policy function and a reward function imitates action data is expressed by, for example, the formula (3) below.

$$\begin{matrix}[ Math . 3 ] & \\ {U}_{i} = {\sum }_{( {S}_{k} , {a}_{k} ) ∈ {D}_{n}} [ {a}_{k} - {P}_{i} ( {r}_{i} ( {S}_{k} ) ) ] & ( 3 )\end{matrix}$$

In the above formula, Uᵢ is an index value representing a degree to which a combination (Pᵢ, rᵢ) of a policy function and a reward function is able to imitate action data. In addition, (Sₖ, aₖ) is a combination of a state vector and an action that is included in the set Dₙ of action data.

The learning unit 2040 determines a combination of a policy function and a reward function that maximizes Uᵢ and employs the determined combination as a result of the n-th round of learning. That is, the result of the (n-1)th update is a policy function and a reward function that maximizes Uᵢ.

Note that the learning unit 2040 does not necessarily have to use all the combinations of a policy function and a reward function that have been generated in the past as a comparison target. For example, the learning unit 2040 may use only a history of a predetermined number of the previous combinations out of the history of combinations of a policy function and a reward function.

Note that, as described above, in order to enable comparison of a policy function and a reward function that are newly obtained with policy functions and reward functions that were obtained in the past, policy functions and reward functions that are obtained in the learning are stored in a storage apparatus as a history. However, when a history that is used in the comparison is limited to a predetermined number of policy functions and reward functions having been obtained in the past, an old policy function and reward function that are not used for the comparison any more may be deleted from the storage apparatus.

### <Processing Flow>

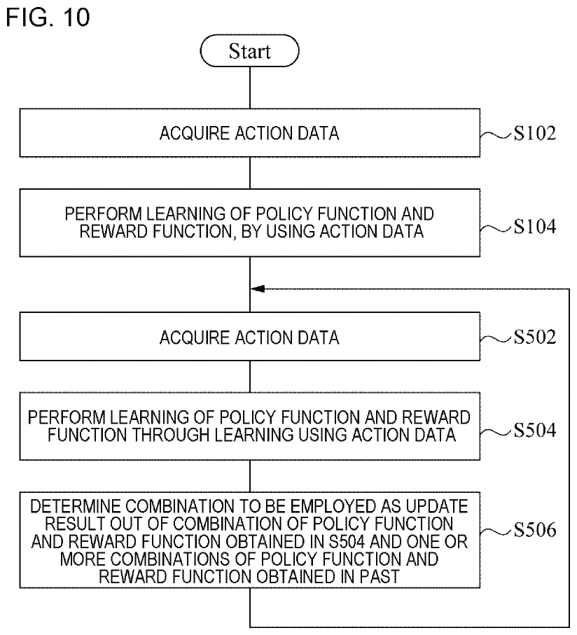

FIG. 10 is a diagram illustrating an example of a processing flow that is performed by the information processing apparatus 2000 of the fourth example embodiment. Note that S102 and S104 are the same steps as those in FIG. 4.

The acquisition unit 2020 acquires action data (S502). The learning unit 2040 performs learning of a policy function and a reward function by use of the acquired action data (S504). The learning unit 2040 determines a combination of a policy function and a reward function that is to be employed as an update result out of a combination of a policy function and a reward function that were obtained in S504 and one or more combinations of a policy function and a reward function that were generated in the past (S506). The policy function and the reward function are updated by the combination determined in S506 (S508).

In the flowchart in FIG. 10, the termination of the processing is not described. However, the information processing apparatus 2000 may terminate the processing illustrated in FIG. 10, based on a predetermined condition. For example, the information processing apparatus 2000 terminates the processing in response to a user operation instructing the termination of the processing.

### <Advantageous Effects>

According to the information processing apparatus 2000 of the present example embodiment, by use of action data that are further obtained after generation of a policy function and a reward function, the policy function and the reward function are updated. Therefore, it is possible to increase the precision of the policy function and the reward function.

As described afore, the information processing apparatus 2000 does not necessarily have to employ a policy function and a reward function that are learned by use of newly obtained action data and may be configured to select appropriate ones out of policy functions and reward functions that have hitherto been obtained. This configuration enables a more appropriate policy function and reward function to be obtained.

While the example embodiments of the present invention have been described above with reference to the drawings, the example embodiments are only exemplification of the present invention, and a combination of the above-described example embodiments or various configurations other than the above-described example embodiments can also be employed.

1. An information processing apparatus comprising:
an acquisition unit that acquires one or more pieces of action data that are data each piece of which associates a state vector representing a state of an environment with an action that is performed in a state represented by the state vector; and
a learning unit that generates a policy function P and a reward function r through imitation learning using the acquired action data, wherein
the reward function r outputs, when given a state vector S as input, a reward r(S) that is acquired in a state represented by the state vector S, and
the policy function accepts, as input, an output r(S) of the reward function upon input of a state vector S and outputs an action a=P(r(S)) to be performed in a state represented by the state vector S.

2. The information processing apparatus according to claim 1, wherein
the learning unit inputs, to the policy function, a reward that is acquired by inputting a state vector that the acquired action data indicate to the reward function and performs learning of the reward function by comparing an action that is acquired as a result of the input with an action associated with the state vector in the action data.

3. The information processing apparatus according to claim 1, wherein
the action data represent a history of actions that a skilled person on the environment performs.

4. The information processing apparatus according to claim 1 further comprising
a learning result output unit that outputs information representing a reward function generated by the learning unit.

5. The information processing apparatus according to claim 1 further comprising
an action output unit that acquires a state vector representing a state of the environment and outputs, by use of the acquired state vector and a policy function and a reward function that are generated by the learning unit, information that represents an action to be performed in an environment in a state represented by the state vector.

6. The information processing apparatus according to claim 1, wherein
the learning unit, after generating the policy function and the reward function, acquires second action data representing actions that an agent actually performs in the environment and performs update of the policy function and the reward function through imitation learning using the second action data.

7. The information processing apparatus according to claim 6, wherein
the learning unit selects, out of a combination of a policy function and a reward function that are acquired by use of the second action data and one or more combinations of a policy function and a reward function that have hitherto been acquired, one combination, and determines a policy function and a reward function of the selected combination as a policy function and a reward function after update.

8. A control method performed by a computer, the method comprising:
acquiring one or more pieces of action data that are data each piece of which associates a state vector representing a state of an environment with an action that is performed in a state represented by the state vector; and
generating a policy function P and a reward function r through imitation learning using the acquired action data, wherein
the reward function r outputs, when given a state vector S as input, a reward r(S) that is acquired in a state represented by the state vector S, and
the policy function accepts, as input, an output r(S) of the reward function upon input of a state vector S and outputs an action a=P(r(S)) to be performed in a state represented by the state vector S.

9. The control method according to claim 8, wherein,
in the imitation learning, a reward that is acquired by inputting a state vector that the acquired action data indicate to the reward function is input to the policy function and learning of the reward function is performed by comparing an action that is acquired as a result of the input with an action associated with the state vector in the action data.

10. The control method according to claim 8, wherein
the action data represent a history of actions that a skilled person on the environment performs.

11. The control method according to claim 8any one of claims 8, further comprising
outputting information representing a generated reward function.

12. The control method according to claim 8, further comprising
acquiring a state vector representing a state of the environment and outputting, by use of the acquired state vector and a policy function and a reward function that are generated, information that represents an action to be performed in an environment in a state represented by the state vector.

13. The control method according to claim 8, further comprising
acquiring second action data representing actions that an agent actually performs in the environment after the policy function and the reward function are generated; and
updating the policy function and the reward function is performed through imitation learning using the second action data.

14. The control method according to claim 13, further comprising
selecting one combination out of a combination of a policy function and a reward function that are acquired by use of the second action data and one or more combinations of a policy function and a reward function that have hitherto been acquired; and
determining a policy function and a reward function of the selected combination is as a policy function and a reward function after update.

15. A non-transitory storage medium storing a program causing a computer to execute a control method, the control method comprising:
acquiring one or more pieces of action data that are data each piece of which associates a state vector representing a state of an environment with an action that is performed in a state represented by the state vector; and
generating a policy function P and a reward function r through imitation learning using the acquired action data, wherein the reward function r outputs, when given a state vector S as input, a reward r(S) that is acquired in a state represented by the state vector S, and the policy function accepts, as input, an output r(S) of the reward function upon input of a state vector S and outputs an action a=P(r(S)) to be performed in a state represented by the state vector S.
